(19) United States
(12) Patent Application Publication
(10) Pub. No.: US 2018/0141195 A1
(43) Pub. Date: May 24, 2018

(54) OIL FILTER PLIERS

(71) Applicant: Sing Fu Jin Precision Industrial Co., Ltd., Nantou City (TW)

(72) Inventor: Wen-Ho Huang, Nantou City (TW)

(21) Appl. No.: 15/356,637

(22) Filed: Nov. 20, 2016

(51) Int. Cl. B25B 27/00; B25B 7/04

(52) U.S. Cl. CPC B25B 27/0042; B25B 7/04

(57) ABSTRACT

Oil filter pliers contains: a fixed part, a movable part, a hollow grip handle, and a press handle. The grip handle is connected with the fixed part which includes a first clamping arm and a hollow connection section, and the moveable part includes an slidable extension and a second clamping arm corresponding to the first clamping arm, wherein the second clamping arm moves close to or away from the first clamping arm by sliding the slidable extension relative to the grip handle. The movable part further includes a first toothed section, the press handle is rotatably coupled with the hollow connection section and includes a driving block and a second toothed section partially engaging with the first toothed section, and between the press handle and the grip handle is defined a torsion spring abutting against the press handle and the grip handle.

### BACKGROUND OF THE INVENTION

### Field of the Invention

The present invention relates to oil filter pliers which are capable of adjusting the clamping distance between the first clamping arm and the second camping arm of the oil filter pliers based on the oil filters of different sizes.

### Description of the Prior Art

Oil filters of various sizes are replaced by a removal tool, such as a chain fastener, but this chain fastener is operated by user's two hands troublesomely.

A fixing loop is also employed to replace an oil filter and contains a toothed retainer configured to retain the oil filter, yet a size of the fixing loop is fixed, so it cannot replace the oil filters of various sizes.

The present invention has arisen to mitigate and/or obviate the afore-described disadvantages.

### SUMMARY OF THE INVENTION

The primary objective of the present invention is to provide oil filter pliers which are capable of adjusting the clamping distance between the first clamping arm and the second camping arm of the oil filter pliers based on the oil filters of different sizes.

Another objective of the present invention is to provide oil filter pliers which after adjusting the clamping distance, the first clamping arm and the second clamping arm of the oil filter pliers are fixed and are removed from the oil filters easily and quickly.

To obtain the above objectives, oil filter pliers provided by the present invention contains: a fixed part, a movable part, a grip handle, and a press handle.

The grip handle is hollow and is in connection with one end of the fixed part, the fixed part includes a first clamping arm and a hollow connection section defined between the first clamping arm and the grip handle, and the moveable part includes an slidable extension accommodated in the grip handle and includes a second clamping arm corresponding to the first clamping arm, wherein the second clamping arm moves close to or away from the first clamping arm by sliding the slidable extension relative to the grip handle, and the movable part further includes a first toothed section arranged on an inner wall of the slidable extension.

The press handle is rotatably coupled with the hollow connection section of the fixed part and includes a driving block housed in the hollow connection section. The press handle also includes a second toothed section arranged on a first edge thereof and partially engaging with the first toothed section, and between the press handle and the grip handle is defined a torsion spring abutting against the press handle and the grip handle.

Preferably, the driving block also has a third toothed section arranged on a second edge thereof, and the fixed part further includes a positioning member rotatably connected with the hollow connection section, wherein the positioning member has an operation stem operated by a user and has a limitation stem corresponding to the driving block, and the limiting stem has a fourth section removing from or engaging with or the third toothed section.

Preferably, the grip handle further includes a returning spring housed therein and configured to pull the slidable extension.

Preferably, the fixed part further includes two arcuate troughs defied on two side surfaces of the hollow connection section, respectively, and the press handle includes a fixing post inserted through the two arcuate troughs.

### BRIEF DESCRIPTION OF THE DRAWINGS

FIG. 1 is a perspective view showing the assembly of oil filter pliers according to a preferred embodiment of the present invention.

FIG. 2 is a perspective view showing the exploded components of the oil filter pliers according to the preferred embodiment of the present invention.

FIG. 3 is a cross sectional view showing the operation of the oil filter pliers according to the preferred embodiment of the present invention.

FIG. 4 is another cross sectional view showing the operation of the oil filter pliers according to the preferred embodiment of the present invention.

FIG. 5 is also another cross sectional view showing the operation of the oil filter pliers according to the preferred embodiment of the present invention.

### DETAILED DESCRIPTION OF THE PREFERRED EMBODIMENTS

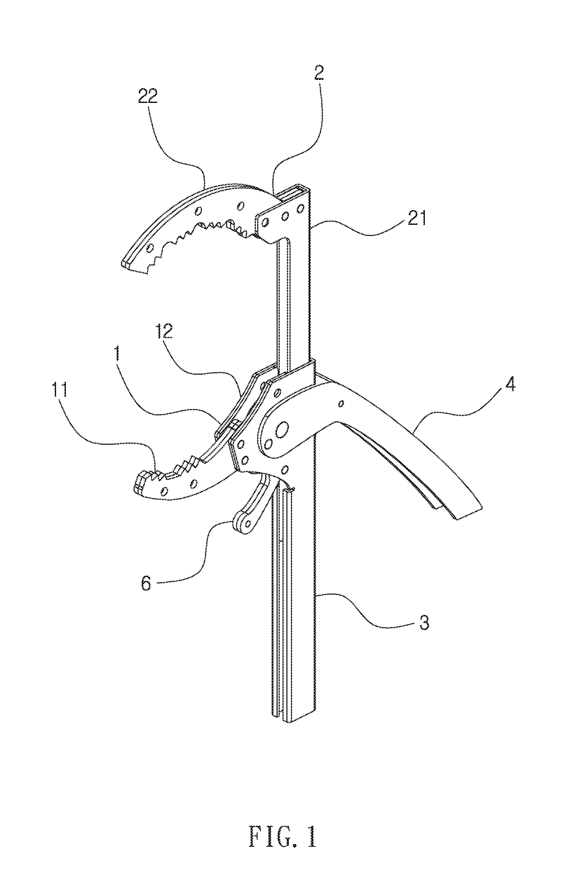

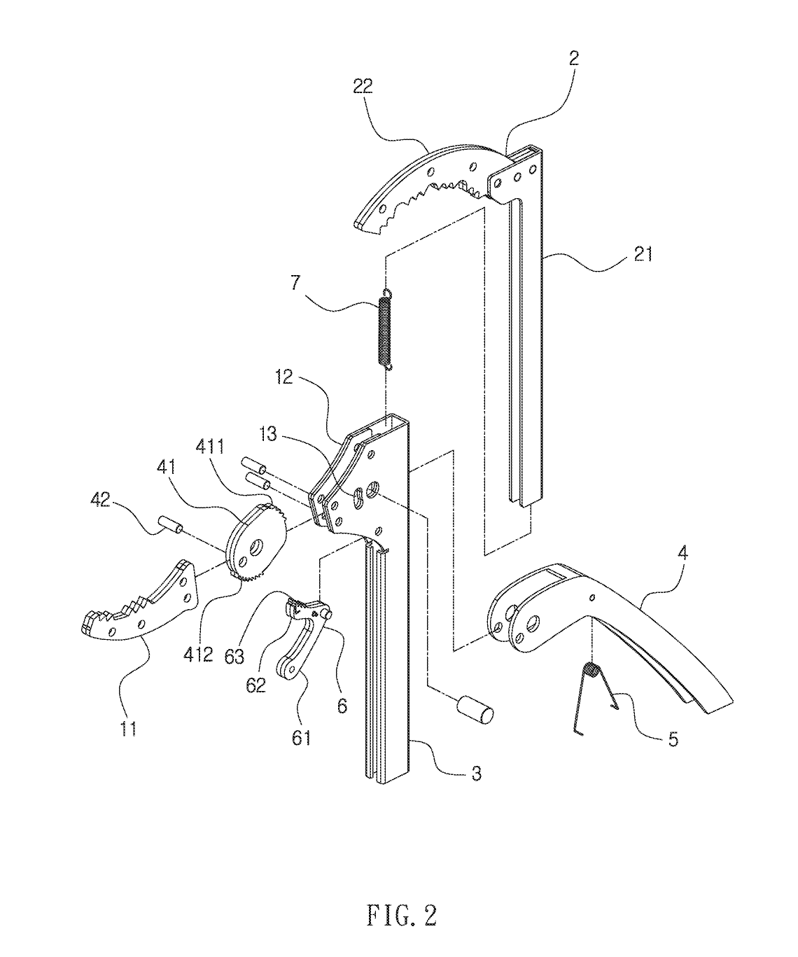

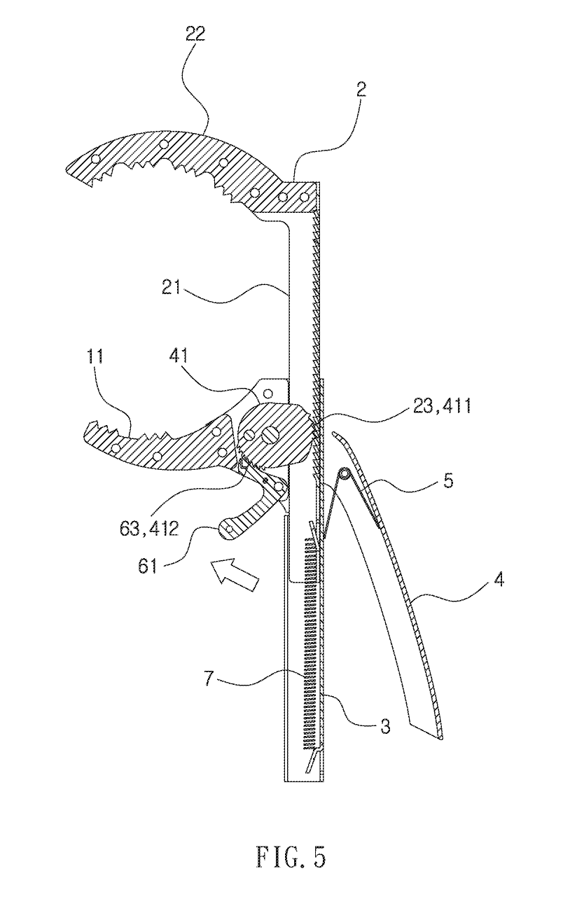

With reference to FIGS. 1 to 5, oil filter pliers according to a preferred embodiment of the present invention comprise: a fixed part 1, a movable part 2, a grip handle 3, and a press handle 4.

The grip handle 3 is hollow and is in connection with one end of the fixed part 1, the fixed part 1 includes a first clamping arm 11 and a hollow connection section 12 defined between the first clamping arm 11 and the grip handle 3, and the moveable part 2 includes an slidable extension 21 accommodated in the grip handle 3 and includes a second clamping arm 22 corresponding to the first clamping arm 11, wherein the second clamping arm 22 moves close to or away from the first clamping arm 11 by sliding the slidable extension 21 relative to the grip handle 3, and the movable part 2 further includes a first toothed section 23 arranged on an inner wall of the slidable extension 21.

The press handle 4 is rotatably coupled with the hollow connection section 12 of the fixed part 1 and includes a driving block 41 housed in the hollow connection section 12, the press handle 4 also includes a second toothed section 411 arranged on a first edge thereof and partially engaging with the first toothed section 23, and between the press handle 4 and the grip handle 3 is defined a torsion spring 5 abutting against the press handle 4 and the grip handle 3.

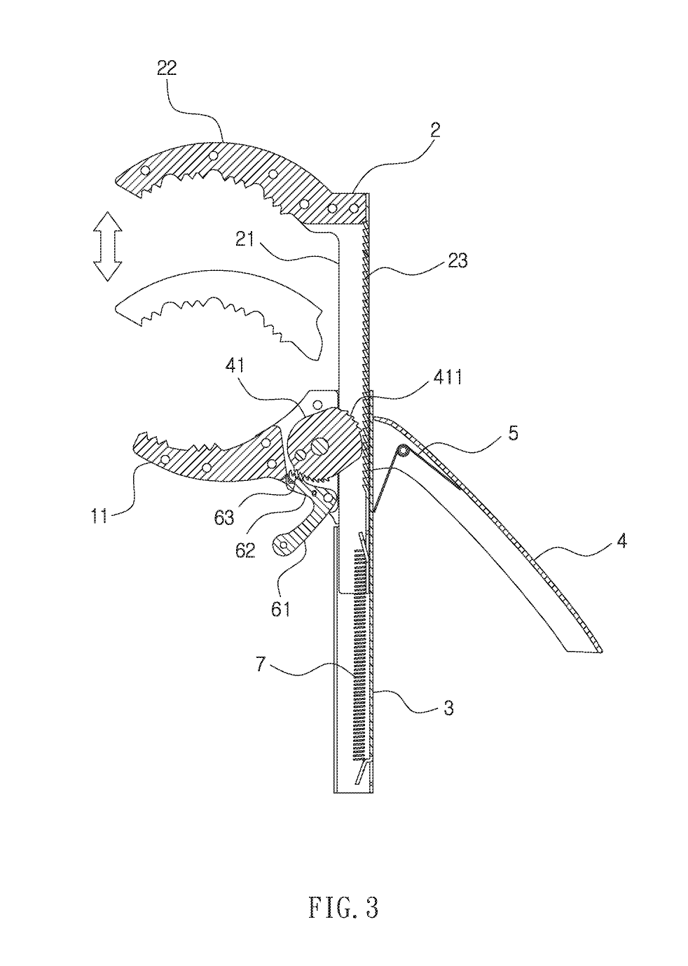

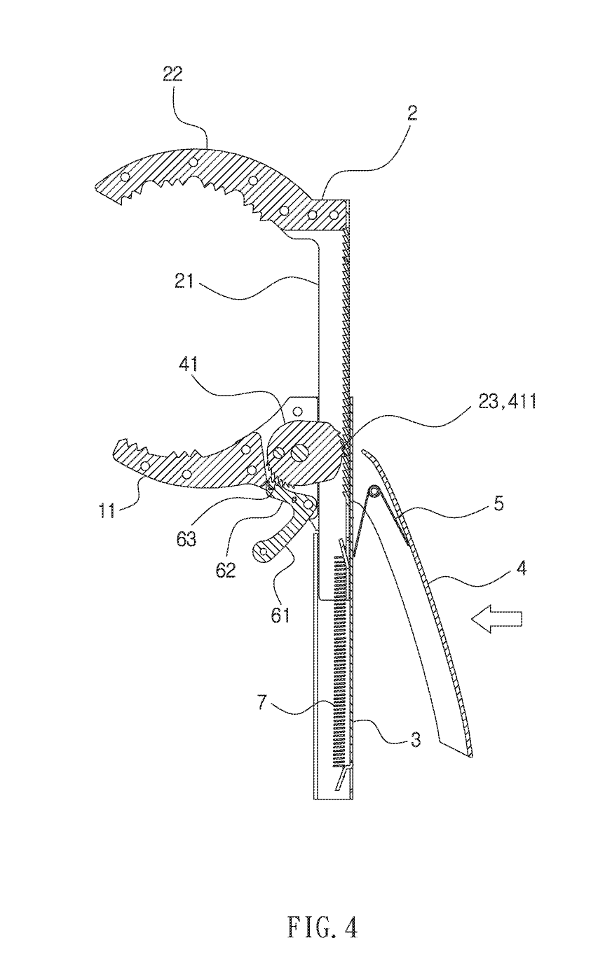

In operation, a clamping distance between the second clamping arm 22 and the first clamping arm 11 is adjustable by sliding the slidable extension 21 relative to the grip handle 3 (as shown in FIG. 3) so as to clamp oil filters of different sizes. Thereafter, the grip handle 3 and the press handle 4 are held and rotated by a user so that the second toothed section 411 partially engages with the first toothed section 23 of the slidable extension 21, thus fixing the first clamping arm 11 and the second clamping arm 22 (as illustrated in FIG. 4).

The driving block 41 also has a third toothed section 412 arranged on a second edge thereof, and the fixed part 1 further includes a positioning member 6 rotatably connected with the hollow connection section 12, wherein the positioning member 6 has an operation stem 61 operated by the user and has a limitation stem 62 corresponding to the driving block 41, and the limiting stem 62 has a fourth section 63 removing from or engaging with or the third toothed section 412, hence when the second toothed section 411 engages with the first toothed section 23 and the operation stem 61 is pushed outwardly, the fourth section 63 engages with the third toothed section 412 so that the first clamping arm 11 and the second clamping arm 22 are fixed.

Furthermore, the grip handle 3 further includes a returning spring 7 housed therein and configured to pull the slidable extension 21.

The fixed part 1 further includes two arcuate troughs 13 defied on two side surfaces of the hollow connection section 12, respectively, and the press handle 4 includes a fixing post 42 inserted through the two arcuate troughs 13, hence the fixing post 42 slides in the two arcuate troughs 13 so as to adjust a pressing travel of the press handle 4. Preferably, the fixing post 42 is not coaxial with the press handle 42 and the driving block 41 so that the press handle 4 is pressed by the user to drive the driving block 41 to rotate.

Accordingly, the clamping distance between the first clamping arm and the second camping arm of the oil filter pliers is adjustable based on the oil filters of different sizes. Preferably, after adjusting the clamping distance, the first clamping arm and the second clamping arm are fixed and are removed from the oil filters easily and quickly.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. Oil filter pliers comprising: a fixed part, a movable part, a grip handle, and a press handle;
wherein the grip handle is hollow and is in connection with an end of the fixed part, the fixed part includes a first clamping arm and a hollow connection section defined between the first clamping arm and the grip handle, and the moveable part includes a slidable extension slidably accommodated in the grip handle and further includes a second clamping arm corresponding to the first clamping arm, wherein the second clamping arm moves towards or away from the first clamping arm by sliding the slidable extension relative to the grip handle, and the movable part further includes a first toothed section arranged on an inner wall of the slidable extension;
wherein the press handle is rotatably coupled with the hollow connection section of the fixed part and rotably engages a driving block, the driving block rotably housed in the hollow connection section and including a second toothed section arranged on a first edge of the driving block, the second toothed section engaging with the first toothed section, and between the press handle and the grip handle is defined a torsion spring abutting against the press handle and the grip handle.

2. The oil filter pliers as claimed in claim 1, wherein the driving block further includes a third toothed section arranged on a second edge thereof, and the fixed part further includes a positioning member rotatably connected with the hollow connection section, wherein the positioning member has an operation stem operable by a user and a limiting stem corresponding to the driving block, the limiting stem having a fourth toothed section selectively engaging with the third toothed section.

3. The oil filter pliers as claimed in claim 1, wherein the grip handle further includes a returning spring housed therein and configured to pull the slidable extension.

4. The oil filter pliers as claimed in claim 3, wherein the fixed part further includes two arcuate troughs defined on two side surfaces of the hollow connection section, respectively, and a fixing post is inserted through the two arcuate troughs and engaging the press handle and the driving block.
